(19) United States
(12) Patent Application Publication
(10) Pub. No.: US 2017/0124409 A1
(43) Pub. Date: May 4, 2017

(54) CASCADED NEURAL NETWORK WITH SCALE DEPENDENT POOLING FOR OBJECT DETECTION

(71) Applicant: NEC Laboratories America, Inc., Princeton, NJ (US)

(72) Inventors: Wongun Choi, Lexington, MA (US); Fan Yang, Hyattsville, MD (US); Yuanqing Lin, Sunnyvale, CA (US)

(21) Appl. No.: 15/343,017

(22) Filed: Nov. 3, 2016

Related U.S. Application Data
(60) Provisional application No. 62/250,750, filed on Nov. 4, 2015.

(51) Int. Cl. G06K 9/00; G06N 3/04; G06K 9/66; G06K 9/46; G06K 9/42

(52) U.S. Cl. CPC G06K 9/00979; G06K 9/4671; G06K 9/42; G06K 9/4628; G06K 9/66; G06N 3/04

(57) ABSTRACT

A computer-implemented method for training a convolutional neural network (CNN) is presented. The method includes receiving regions of interest from an image, generating one or more convolutional layers from the image, each of the one or more convolutional layers having at least one convolutional feature within a region of interest, applying at least one cascaded rejection classifier to the regions of interest to generate a subset of the regions of interest, and applying scale dependent pooling to convolutional features within the subset to determine a likelihood of an object category.

### RELATED APPLICATION INFORMATION

This application claims priority to 62/250,750 filed on Nov. 4, 2015, incorporated herein by reference in its entirety.

### BACKGROUND

Technical Field

The present invention relates to image processing, and more particularly to convolutional neural networks using scale dependent pooling and cascaded rejection classifiers for object detection.

Description of the Related Art

Convolutional Neural Networks (CNNs) have contributed to various computer vision challenges due to its capability to learn discriminative features at different level of granularities. Regions having CNN features (R-CNN) have been proposed for object detection, where a pre-trained network is fine-tuned to classify thousands of object proposals. However, both training and testing suffer from low efficiency since the network performs a forward pass on every single object proposal and/or layer independently instead of overlapping.

In order to reduce the computational cost, recent CNN based object detectors, such as Fast RCNN and Spatial pyramid pooling networks (SPPnet), share the features generated by convolutional layers and apply a multi-class classifier for each candidate bounding box. Fast RCNN employs convolutional operations which are performed only once on whole features, and object proposals are pooled from only the last convolutional layer and fed into fully-connected (FC) layers to evaluate the likelihood of object categories.

However, Fast RCNN cannot handle small objects well. For example, since the candidate bounding boxes are pooled directly from the last convolutional feature maps rather than being warped into a canonical size, they do not contain enough information for decision if the boxes are too small. Multi-scale input schemes limit the applicability of deep architecture due to memory constraints and introduces additional computational burden into the process. As a result, pooling a huge number of candidate bounding boxes and feeding them into high-dimensional FC layers can be extremely time-consuming.

### SUMMARY

According to an aspect of the present principles, a computer-implemented method for training a convolutional neural network (CNNs) is provided. The method includes receiving regions of interest from an image, generating one or more convolutional layers from the image, each of the one or more convolutional layers having at least one convolutional feature within a region of interest, applying at least one cascaded rejection classifier to the regions of interest to generate a subset of the regions of interest, and applying scale dependent pooling to convolutional features within the subset to determine a likelihood of an object category.

According to another aspect of the present principles, a system for training a convolutional neural network (CNN) is presented. The system includes a memory and a processor in communication with the memory, wherein the processor is configured to receive regions of interest from an image, generate one or more convolutional layers from the image, each of the one or more convolutional layers having at least one convolutional feature within a region of interest, apply at least one cascaded rejection classifier to the regions of interest to generate a subset of the regions of interest, and apply scale dependent pooling to convolutional features within the subset to determine a likelihood of an object category.

According to another aspect of the present principles, a non-transitory computer-readable storage medium comprising a computer-readable program for training a convolutional neural network (CNN) is presented, wherein the computer-readable program when executed on a computer causes the computer to perform the steps of receiving regions of interest from an image, generating one or more convolutional layers from the image, each of the one or more convolutional layers having at least one convolutional feature within a region of interest, applying at least one cascaded rejection classifier to the regions of interest to generate a subset of the regions of interest, and applying scale dependent pooling to convolutional features within the subset to determine a likelihood of an object category.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method for training a convolutional neural network (CNN), in accordance with an embodiment of the present invention;

FIG. 2 is a block/flow diagram illustrating a system/method for training a convolutional neural network (CNN), in accordance with an embodiment of the present invention;

FIG. 3 is a block/flow diagram illustrating a system/method for training a convolutional neural network (CNN), in accordance with an embodiment of the present invention;

FIG. 4 is a block/flow diagram of an exemplary processing system to which the present principles may be applied, in accordance with an embodiment of the present invention; and

FIG. 5 is a flow diagram illustrating a system/method for training a convolutional neural network (CNN), in accordance with an embodiment of the present invention.

### DETAILED DESCRIPTION OF PREFERRED EMBODIMENTS

Embodiments of the present invention provide systems and methods for a conventional neural network (CNN) for visual object detection within a given image using cascaded rejection classifiers with scale dependent pooling for efficient and accurate object detection. In addition, the present invention proposes a method and system for training a convolutional neural network (CNN) for visual object detection given an image.

In some embodiments, the systems/methods described herein employ a convolutional neural network to learn a representation of an object within the image and improve the representation using scale-dependent pooling and/or layer-dependent cascaded rejection classifiers. In an embodiment, cascaded rejection classifiers (CRC) are employed by utilizing features from different convolutional layers within a single network, rather than combining different networks. In a further embodiment, scale-dependent pooling (SDP) enables sharing of a single convolutional feature per image while effectively processing scale-variation of objects within the image.

The present invention may identify/recognize object of interests (e.g., car, pedestrian, etc.) within images accurately and estimate the location such objects within the image space efficiently. Exemplary applications/uses to which the present invention can be applied include, but are not limited to visual recognition, such as object detection/recognition, object classification, scene classification, image retrieval, etc. In some embodiments, the cascaded rejection classifiers (CRC) effectively utilize convolutional features and eliminate negative bounding boxes in a cascaded manner, which greatly speeds up the object detection while maintaining high accuracy. In addition, scale-dependent pooling (SDP) can improve detection accuracy by exploiting appropriate convolutional features depending on the scale of the candidate object proposal. Advantageously, the present invention can detect objects more accurately and efficiently in various driving scenarios (e.g., Autonomous vehicle applications, Advanced driver Assistance systems (ADAS), etc.). For example, small objects are more accurately detected with an approximate 5-20% increase in detection accuracy while processing such images much faster (e.g., twice as fast) than conventional methods.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

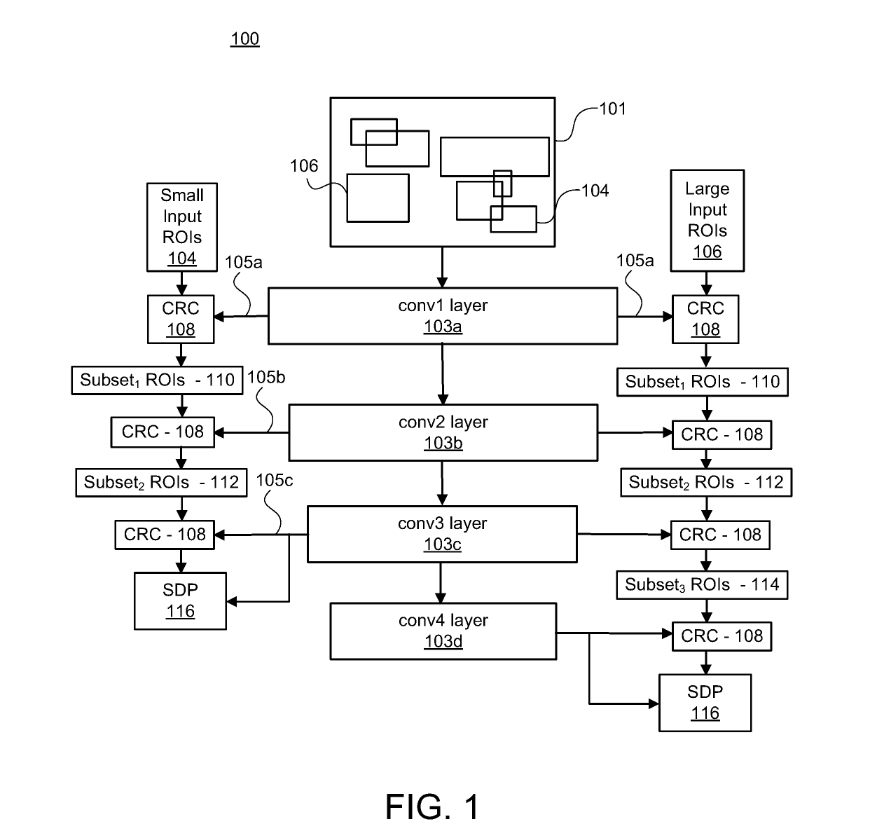

Referring now in detail to the figures in which like numerals represent the same or similar elements and initially to FIG. 1, a system/method 100 for training a convolutional neural network (CNN) for object detection is illustratively depicted in accordance with one embodiment of the present principles. The system/method 100 described herein exploits convolutional features 105 in all convolutional layers 103 to reject easy negatives via cascaded rejection classifiers 108, and evaluates surviving proposals using scale-dependent pooling 116.

Object recognition/detection is a branch of computer vision for finding and identifying objects in an image and/or video sequence. In any given image and/or video sequence, object recognition detects all objects, such as a restricted class of objects dependent on a dataset, and each object is localized using a bounding box which is identified with a label. The bounding box may be representative of a region of interest (ROI) within the given image and/or video sequence. For example, a bounding box can identify a car, a bicycle, a pedestrian, etc. within the image space. In object detection, each image pixel can be classified whether it belongs to a particular class (e.g., car, bicycle, pedestrian, etc.) or not, for example, by grouping pixels together to form bounding boxes.

In one embodiment, convolutional neural networks (CNNs) including scale dependent pooling and/or cascaded rejection classifiers are provided. Generally, CNNs allow real time visual object detection using multiple layers (e.g., convolutional layers) of the input image and overlapping the layers to determine a representation of the image. The CNNs include multiple layers of receptive fields, which may be small neuron collections which process portions of the input image. The outputs of these collections are then smoothed so that their input regions overlap to obtain a better representation of the original image, which is repeated for every such convolutional layer.

A CNN architecture is generally formed by a stack of distinct layers, such as convolutional layers, that transform an input volume into an output volume (e.g., holding the class scores) through a differentiable function. Another concept of CNNs includes pooling, which is a form of non-linear down-sampling. Pooling, such as max pooling, partitions an input image into a set of non-overlapping rectangles and, for each such sub-region, outputs a maximum. The pooling layer progressively reduces the spatial size of the representation to reduce the amount of parameters and computation performed in the CNN. The pooling layer operates independently on every convolutional layer of the input image and resizes each convolutional layer spatially. After several convolutional and max pooling layers are processed, reasoning in the CNN is accomplished via fully connected (FC) layers. Neurons in a FC layer have full connections to all activations in the previous layer.

In an embodiment, an image and/or video sequence 101 (hereinafter collectively referred to as “image”) is received. The image 101 can be any image having a plurality of pixels representing a scene, the scene having one or more objects, such as cars, bicycles, pedestrians, etc. within the image. Each image can include one or more regions of interest (ROIs) 104, 106, such as small ROIs 104 and large ROIs 106. A ROI 104, 106 can include a selected subset of samples within a dataset identified for a particular purpose. For example, ROIs 104, 106 can be provided by bounding box proposal methods, such as Selective Search, Edgebox, or Region Proposal Network.

In some embodiments, the ROI 104, 106 can define borders (e.g., a time or frequency interval on a waveform, boundaries of an object within an image, contours or surfaces outlining an object, outline of an object at or during a particular time interval in a time-volume, etc.) of an object under consideration. In some embodiments, the ROIs 104, 106 may be received. In an embodiment, the ROIs 104, 106 may be represented as one or more bounding boxes (e.g., small bounding boxes, large bounding boxes, etc.). The bounding boxes 104, 106 may be determined based on, for example, a number of pixels within each ROI. Such ROIs and/or bounding boxes are representative of “object” proposals, which may contain many false positives.

In an embodiment, the image 101 is separated into a plurality of convolutional layers 103 (e.g., 103a-103d). For example, as illustrated in FIG. 1, the image 101 is separated into a plurality of successive convolutional layers 103a-103d (e.g., conv1, conv2, conv3, conv4, etc.), where conv4 is a last convolutional layer. Each convolutional layer includes at least one convolutional feature 105 within a region of interest (ROI) 104, 106. The outputs of convolutional layers 103 are convolutional features 105. Each convolutional layer 103 takes an input (in a spatial grid form, e.g., either the image 101 or a previous convolutional layer's output), and generates a convolutional feature map.

A convolutional feature 105 is an extracted feature within each respective convolutional layer. The convolutional features 105 can include, for example, an area of a particular density which can carry over one or more convolutional layers. In an embodiment, the convolutional operation (e.g., separation of convolutional layers) is performed only once per image 101 to avoid any redundant feature extraction. Accordingly, only one set of convolutional features/layers for an image 101 is generated. Each output of a convolutional layer 103 becomes the input for the next subsequent convolutional layer 103. For example, the input for conv2 layer 103b is an activation map of conv1 layer 103a. Each activation map represents more and more complex features within the image.

In some embodiments, a ROI pooling layer (not shown) performs max pooling on each convolutional layer 103 to convert the convolutional features 105 inside any valid ROI 104, 106 into a small feature map having a fixed spatial extent of height H multiplied by width W, where H and W are layer hyper-parameters that are independent of any particular ROI. The output of ROI pooling can be passed to an SDP module. Convolutional layer features 105, thus, become smaller as each convolutional layer 103 is generated since there are layers that spatially sub-sample (such as max-pooling or convolution with spatial stride size larger than 1).

As illustrated in FIG. 1, each subsequent convolutional layer 103 is, therefore, smaller than the previous convolutional layer 103. For example, conv4 layer 103d is smaller than conv3 layer 103c, conv3 layer 103c is smaller than conv2 layer 103b, and conv2 layer 103h is smaller than conv1 layer 103a. Convolutional layers' feature map becomes smaller due to max-pooling or strided convolution. Because a number of channels in later convolutional layers are much larger, it may be beneficial to have a smaller map to reduce computational burden.

Visual semantic concepts of an object can emerge in different convolutional layers 103 depending on a size of target object(s) within the image 101. These visual semantic concepts can include, for example, convolutional features 105 representative of a portion of a target object. Target objects may include objects to be detected within an image, such as cars or pedestrians. Visual semantic concepts include abstract visible elements, such as small parts of an objects (e.g., eye, wheel, etc.) or low level salient features (e.g., edges, corners, texture, etc.). For example, if a target object (e.g., a pedestrian) within the image 101 is small, a strong activation of convolutional neurons (e.g., convolutional features 105) may be present in an earlier convolutional layer 103c (e.g., conv3) which encodes specific parts of an object. On the other hand, if a target object is large (e.g., a car), the same part concept may emerge in a subsequent convolutional layer 103d (e.g., conv4).

For each convolutional layer 103, the set of input ROIs 104, 106 are progressively reduced using each convolutional layer's feature 105 and at least one cascaded rejection classifier (CRC) to generate a new set of ROIs 110 that are a subset of the input ROIs 104, 106. For example, assuming that the input ROIs are small ROIs 104, the cascaded rejection classifier 108 reduces the number of bounding box proposals to generate a subset of ROIs 110. This process can be repeated for all convolutional layers 103 such that a fewer number of object proposals remain at the end after all convolutional layers 103 have been processed. For example, the new set of ROIs 110 and a CRC 108 can be employed to further reduce the number of ROIs in a subsequent convolutional layer and generate new subsets of ROIs (e.g., Subset₁ ROIs 112, Subset₂ ROIs 114, etc.), as illustrated in FIG. 1.

A cascaded rejection classifier (CRC) 108 can include hundreds or thousands of “positive” sample views of a particular object (e.g., a bicycle, car, pedestrian, etc.) and arbitrary “negative” images of an object having approximately the same size. Theses classifiers 108 can be applied to a region of interest within an image to detect not only an object in question, but also to reject any regions of interest where the particular object is not found/located. For example, a CRC 108 of a bicycle can be used to detect a ROI having a feature of a bicycle (e.g., wheel, handle bar, etc.) and can also eliminate any ROI not having a feature of a bicycle (e.g., a non-object proposal, such as the sky).

The cascading direction can be defined over the set of convolutional layers 103 in the CNN. In an embodiment, the convolutional features 105 in the early convolutional layers 103 can be defined as and/or representative of a weak classifier and/or boosting classifier. Although features 105 from earlier convolutional layers 103 may be too weak to make a strong evaluation of an object category, such features 105 can be useful to quickly reject easy negatives. After the rejection classifier 108 is trained, the classifier 108 can be applied to a region of an image to detect a target object in question. To search for the object in the entire image 101, a search window can be moved across the image 101 to check every location for the classifier. Thus, CRCs 108 can effectively reduce the number of ROIs by rejecting any ROIs 104, 106 and/or regions within each subset which do not include the classifier 108. For example, assuming the rejection classifier includes data representative of a pedestrian, the CRC 108 can reduce the ROIs 104, 106 to a subset of ROIs 110, where the subset of ROIs 110 include data representative of a pedestrian and eliminate any ROIs that do not include data representative of a pedestrian.

By comparison, Fast RCNN requires every object proposal to be pooled by the ROI pooling layer and fed into FC layers, which is computationally expensive given that the number of proposals and neurons in FC layers are huge. True objects are usually much fewer than the total number of object proposals. Given thousands or tens of thousands of object proposals, most of them cover the background region that does not contain an object, while only a relatively small number of them actually correspond to true objects. If the background proposals can be eliminated early before going through ROI pooling and FC layers, the time for FC layer computations can be greatly reduced. Advantageously, cascaded rejection classifiers described in the present invention are much faster than final object classifiers, so the efficiency gain due to reduced number of ROIs is much larger than any additional computations introduced by the rejection classifiers.

Accordingly, cascaded rejection classifiers 108 filter out certain ROIs, leaving much fewer hard negatives for later evaluation using more features from additional convolutional layers 103. Because different convolutional layers 103 capture different levels of information, some non-object proposals (e.g., non-conforming convolutional features) can be found and rejected by inspecting convolutional features at lower or intermediate convolutional layers 103. A non-conforming convolutional feature is an element which does not match to a previously defined feature within the CRC. Thus, the present invention employs rejection classifiers 108 to reject non-object proposals at each convolutional layer 103 in a cascaded manner. Advantageously, cascaded rejection classifiers (CRC) 108 effectively utilize convolutional features and eliminate negative bounding boxes in a cascaded manner, which greatly speeds up the detection while maintaining high accuracy.

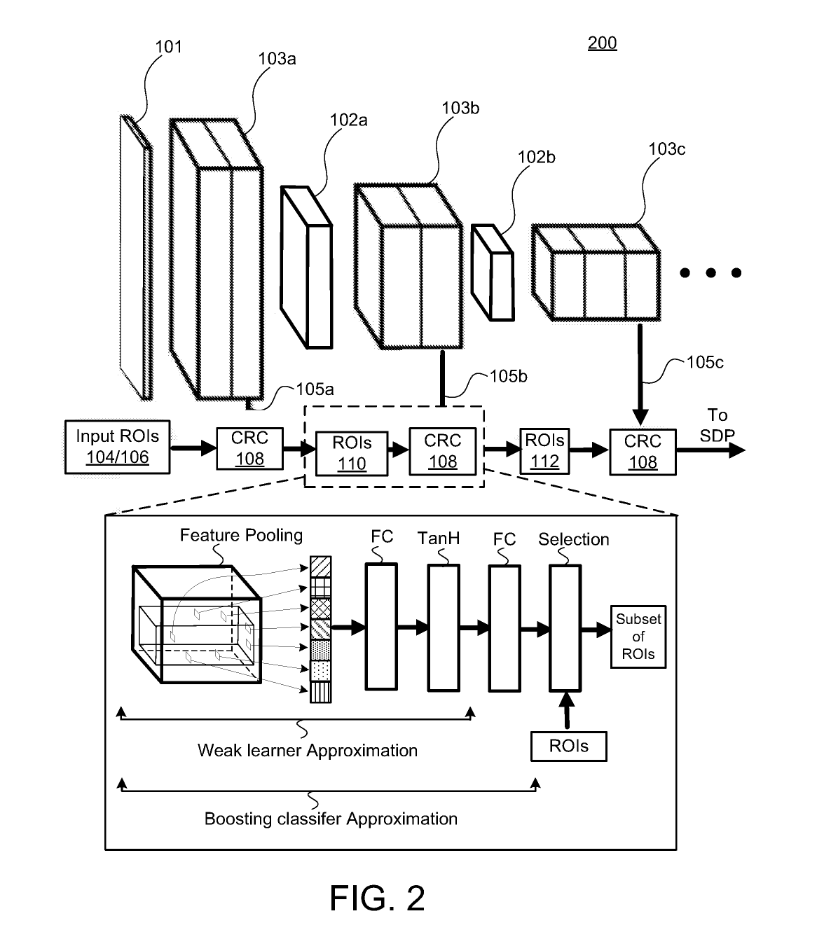

Now referring to FIG. 2, a detailed structure of applying cascaded rejection classifiers is illustratively depicted. Given a set of ROIs 104, 106 and a corresponding convolutional feature map, a CRC module can extract a set of features 105 within each ROI 104, 106 and determine whether to keep or disregard it. The extracted features are aggregated via a boosting classifier that produces an output score. Accordingly, the output score is used to determine whether to keep a ROI. The ROIs kept by each CRC process are passed to the next convolutional layer's CRC module.

In FIG. 2, successive convolutional layers 103a-c are generated for the image 101 using max pooling layers 102a-b. For each convolutional layer 103a-c, features 105a-c are extracted and a corresponding rejection classifier 108 is applied to obtain classification scores. Classification scores are an output score for each ROI in CRC, which is used to determine whether to keep an ROI or discard the particular ROI. Object proposals having classification scores smaller than a rejection threshold can be discarded. Accordingly, each sub-set of ROIs are smaller than the previous ROIs.

In an embodiment, the cascaded rejection classifiers (CRCs) 108 are learned to reject non-object proposals at each convolutional layer 103 in a cascaded manner. To do this, a pre-trained model with SDP branches is fine-tuned using object proposals divided into groups, and features 105 from feature maps for each proposal are extracted at each convolutional layer 103. Considering the proposals containing an object as positive samples while those containing the background as negative samples, a binary classifier is trained for each group of proposals at a convolutional layer 103 to differentiate objects from the background. By setting a rejection criteria, e.g., keeping 99.9% positives and rejecting 30% negatives, a rejection threshold is obtained such that easy negatives with small classification scores are filtered out at an early stage, while those with classification scores larger than the threshold proceed and are used to train rejection classifiers 108 for subsequent convolutional layers 103.

More formally, suppose there are N proposals that belong to a scale group s, B=[B₁, B₂, . . . , B_{N}] belonging to a specific size group. Given a proposal Bᵢ εB with a label yᵢ=1 if it contains an object and yᵢ=0 otherwise, we pool it from the l-th convolutional layers Lᵢ by ROI pooling, resulting in a m×m×c cuboid, where in is the fixed size of the proposal after ROI pooling and c is the number of channels of the feature maps at the layer Lᵢ. By vectorizing the cuboid, a 1D feature vector xᵢ εR^{m}^{²}^{c×l} for the proposal Bᵢ is obtained. Totally, a training set X=[x₁, x₂, . . . , x_{N}]εR^{m}^{²}^{c×N}, as well as a label set Y={0,1}εR^{N}, is obtained to learn the rejection classifier. A discrete Adaboost classifier may be used as a rejection classifier due to its efficiency. The proposals that meet the rejection criteria are kept to train classifiers for subsequent layers. During a forward pass in a test phase, after each convolutional layer 103, proposals are pool out by ROI pooling, features 105 are extracted and the corresponding rejection classifier 108 is applied to obtain classification scores. Those proposals with classification scores smaller than the rejection threshold can be discarded. Accordingly, a large number of negatives are rejected progressively by consecutive convolutional layers 103 and will not go through SDP, which dramatically speeds up the process.

To further accelerate the computation, a series of network layers is employed to approximate the behavior of the rejection classifiers such that the rejection classifiers can be included in the network structure as a whole and run on a graphic processing unit (GPU). A linear boosting classifier F can be written as F(x)=Σₜ₌₁^{T}wₜhₜ(x), where hₜ is a weak learner, wₜ is the corresponding weight and the output is the classification score. A weak learner hₜ is a decision stump that outputs 1 if the value xᵥ at a specific v-th feature dimension is greater than a decision threshold δ and −1 otherwise, represented as hₜ(x)=sign(xᵥ−δ).

To approximate the weak learner, a feature pooling layer is implemented which is adapted from an ROI pooling layer by only pooling features at specific locations on the feature maps to form a T-dimensional vector rather than an m×m×c cuboid. The location to pool features can be pre-calculated by back-projecting the feature dimensions selected by boosting classifiers to the convolutional feature maps. The feature pooling layer may be connected to the corresponding convolutional layer where the boosting classifier is learned, followed by an FC layer and a hyperbolic (tan h) layer. The weight of the FC layer is an identity matrix while the bias is initialized as −δ. The hyperbolic layer provides a nice approximation to the sign function, and is differentiable everywhere, which guarantees that the gradients can be back-propagated to lower layers. On top of the weak learner approximation, another FC layer is employed to construct the classifier F, where the weight is initialized as a diagonal matrix by wₜ and the bias is negative rejection threshold. Given a proposal and the convolutional feature maps as the inputs of the feature pooling layer, the output of the entire approximation is a number indicating whether the proposal should be rejected or not. By using a feature pooling layer, a hyperbolic layer and two FC layers, the rejection classifiers may be approximated by a network module that can be easily incorporated into the network and runs on a GPU.

Only the trained rejection classifiers have been converted into network layers for efficient detection in the testing phase. Nevertheless, the rejection classifiers can also be used to complement network fine-tuning in the sense that they provide information about which samples are difficult to classify and enforces the network to focus on those hard samples. In particular, the fine-tuning is regularized by providing hard samples, as well as back-propagating information from the rejection classifiers, to make the convolutional filters more discriminative. To achieve this, a selection layer is implemented, which takes, as input, the output indicator of rejection classifiers (e.g., approximated using network layers) and object proposals, and outputs a new and smaller set of proposals for subsequent layers. In the new set of proposals, a large number of proposals have been eliminated while the remaining ones are mostly true positives and hard negatives. Proposals surviving after the selection layer may be more difficult to classify, making the network explicitly learn a more discriminative pattern from them.

With continued reference to FIG. 1, scale-dependent pooling (SDP) 116 is performed on convolutional features within all surviving ROIs for each convolutional layer 103 to determine a likelihood of an object category. For example, SDP 116 can determine a percentage likelihood that the convolutional feature(s) is a pedestrian, car, etc. In some embodiments, there can be multiple SDP modules per size group (e.g., 3 for small, medium and large ROIs). Each SDP processes multiple ROIs that fall into the corresponding size group. SDP is connected to a single convolutional layer, which means that one SDP will pool convolutional features from a single convolutional layer.

Particulars regarding scale dependent pooling 116 are described in detail below with reference to FIG. 2. SDP 116 improves detection accuracy, especially on small objects, by fine-tuning a network with scale-specific branches attached after several convolutional layers 103 by exploiting appropriate convolutional features 105 depending on the scale of candidate object proposals. Scale variation is a fundamental challenge in visual recognition as the scale or size of an object proposal can vary throughout each convolutional layer 103.

Conventional methods, such as R-CNN, SPPnet and FastRCNN either treat the last layer's convolutional outputs and/or pool the features at the last convolutional layer as the features to describe an object. Accordingly, conventional methods address scale variation via image pyramids or brute-force learning methods which are difficult and introduce additional computational burden. In an embodiment, SDP filters disclosed in the present invention can be employed to determine a candidate object bounding box using the convolutional features pooled from a layer corresponding to its scale. Accordingly, SDP determines a likelihood of an object category per ROI (e.g., car 90%, person 5%, etc.)

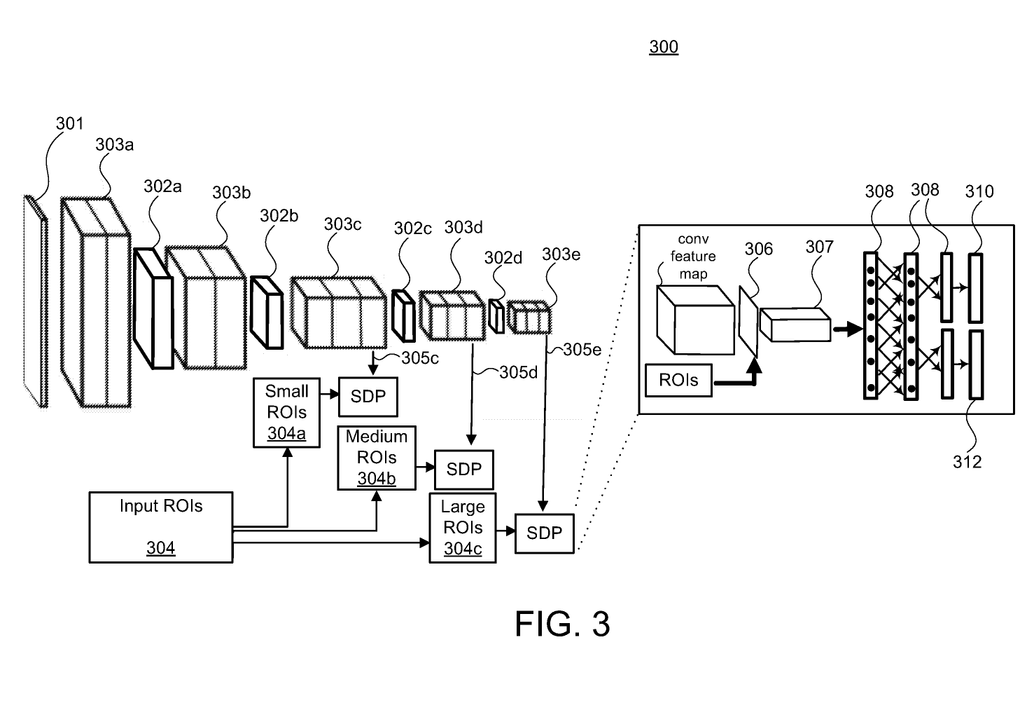

Referring now to FIG. 3, a system/method 300 for training a CNN using scale dependent pooling is illustratively depicted in accordance with an embodiment of the present principles. In FIG. 3, an image 301 is provided/obtained and successive convolutional layers 303a-303e are generated successfully as described above with respect to FIG. 1, where conv5 represents a last convolutional layer. A max pooling layer 302a-302d performs max pooling for each convolutional layer 303, respectively, and convolutional features 305c-e are extracted from each respective convolutional layer 303c-e.

In an embodiment, scale dependent pooling (SDP) is performed by branching out additional FC layers 308 from different convolutional layers 303 for different sizes of object proposals. For example, the object proposals can include small ROIs 304a, medium sized ROIs 304b, and/or large ROIs 304c. For example, small ROIs 304a may include 0˜64 pixel heights, medium ROIs 304b may include 64˜128 pixel heights, and large ROIs 304c may include anything larger than 128 pixel heights. However, the specific definition of scale group may be dependent on the application scenario.

As illustrated in FIG. 3, SDP is performed on, for example, convolutional layers conv3 303c, conv4 303d, and conv5 303e, by determining the scale (e.g., height) of each object proposal and pooling the features 305c-e from a corresponding convolutional layer 303 depending on the scale/height. For example, object proposals of height between 0 and 64 pixels are pooled out from lower convolutional layers (e.g., conv3) rather than the last convolutional layer (e.g., conv5). Similarly, object proposals of height between 64 and 128 pixels can be pooled out earlier (e.g., conv4).

By pooling small object proposals from lower convolutional layers 303 that are relatively large, more neurons that preserve sufficient information for detection are present. Since each branch focuses on a specific scale of object proposals, the learning process is less prone to confusion by various scales of object proposals. In addition, high level semantic concepts (e.g., convolutional features 305c-e) may emerge in different convolutional layers 303 depending on the size of objects. For example, if objects are of small scale, parts of the objects may be captured by neurons of lower or intermediate convolutional layers 303, and not necessarily the last convolutional layer (e.g., conv5). By jointly learning scale-specific FC layers and fine-tuning convolutional layers 303, more discriminative convolutional features can be obtained. Unlike conventional methods, the present invention does not simply combine or encode convolutional features 305 from different layers 303, but rather adds FC layers 308 to enforce convolutional features 305 to learn scale-specific patterns during fine-tuning.

In FIG. 3, the SDP process examines the scale of input ROIs 304 and provides a corresponding classifier among three different classifiers. Accordingly, all surviving ROIs are evaluated by an appropriate object classifier. For example, if a target ROI is small (e.g., smaller than 64 pixels), the classifier attached at conv3 may be chosen. On the other hand, if a target RoI is large, than the classifier attached at conv5 may be chosen. Using the score output of the classifier, detection outputs are generated that have a score higher than a predetermined threshold.

For example, the SDP generates three branches after conv3, conv4 and conv5. Each branch includes an ROI pooling layer 306 and ROI pooling features 307 connected to two successive FC layers 308 for calculating class scores 310 and bounding box regressors 312. The fine-tuning process starts from a pre-trained network. During fine-tuning, input object proposals are first distributed into three groups based on their height and then fed into corresponding ROI pooling layer to pool convolutional features from different feature maps. Gradients are back-propagated from three branches to update corresponding FC layers and convolutional filters. By explicitly enforcing neurons to learn for different scales of objects, the convolutional layers 203 are able to detect small objects at an early stage and effectively improve the detection accuracy on small objects compared to conventional methods.

Advantageously, scale variation of target objects may be efficiently allocated while computing convolutional features 305 only once per image. Instead of artificially resizing the input images in to obtain a proper feature description, SDP efficiently selects a proper feature layer 303 to describe an object proposal. Accordingly, SDP reduces computational cost and memory overhead caused by redundant convolutional operations, resulting in a compact and consistent representation of object proposals.

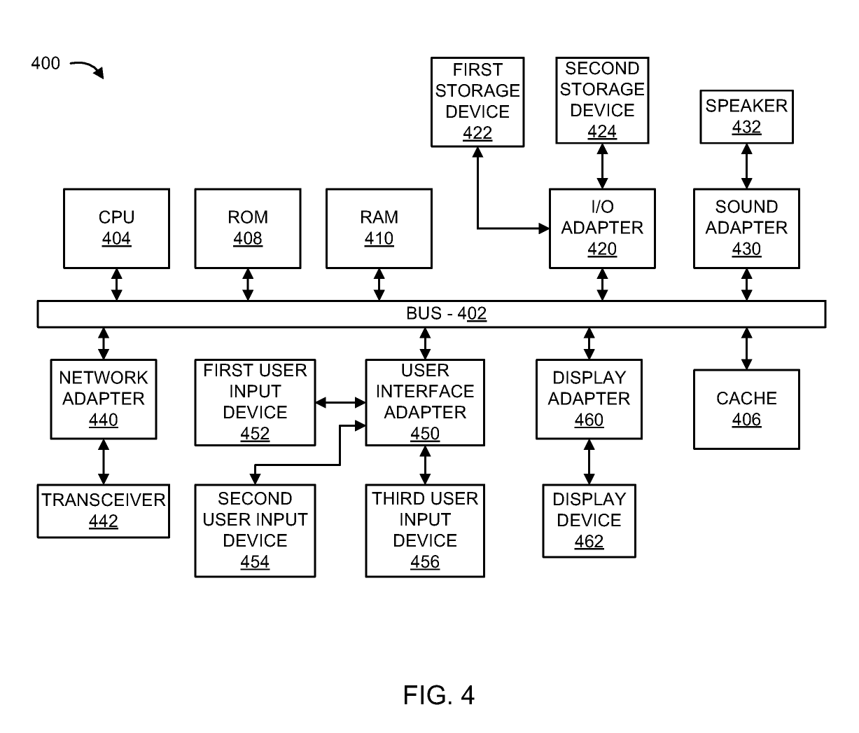

Now referring to FIG. 4, an exemplary processing system 400 to which the present principles may be applied is illustratively depicted in accordance with one embodiment of the present principles. The processing system 400 includes at least one processor (“CPU”) 404 operatively coupled to other components via a system bus 402. A cache 406, a Read Only Memory (“ROM”) 408, a Random Access Memory (“RAM”) 410, an input/output (“I/O”) adapter 420, a sound adapter 430, a network adapter 440, a user interface adapter 450, and a display adapter 460, are operatively coupled to the system bus 402.

A storage device 422 and a second storage device 424 are operatively coupled to system bus 402 by the I/O adapter 420. The storage devices 422 and 424 can be any of a disk storage device (e.g., a magnetic or optical disk storage device), a solid state magnetic device, and so forth. The storage devices 422 and 424 can be the same type of storage device or different types of storage devices. In some embodiments, the CNN can be stored in storage accessible by the system 400, such as storage devices 422, 424 or a network attached storage.

A speaker 432 is operatively coupled to system bus 402 by the sound adapter 330. A transceiver 442 is operatively coupled to system bus 402 by network adapter 440. A display device 462 is operatively coupled to system bus 402 by display adapter 460.

A first user input device 452, a second user input device 454, and a third user input device 456 are operatively coupled to system bus 402 by user interface adapter 450. The user input devices 452, 454, and 456 can be any of a keyboard, a mouse, a keypad, an image capture device, a motion sensing device, a microphone, a device incorporating the functionality of at least two of the preceding devices, and so forth. Of course, other types of input devices can also be used. The user input devices 452, 454, and 456 can be the same type of user input device or different types of user input devices. The user input devices 452, 454, and 456 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present principles provided herein.

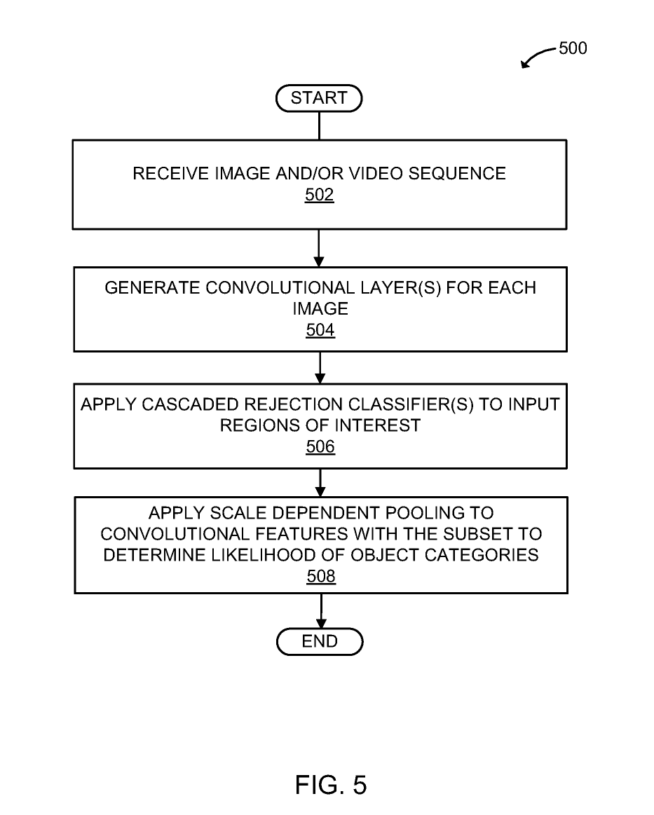

It is to be appreciated that processing system 400 may perform at least part of the method described herein including, for example, at least part of method 500 of FIG. 5.

FIG. 5 is a block/flow diagram of a method for training a convolutional neural network (CNN), in accordance with embodiments of the present invention.

At block 502, an image is received. In some embodiments, regions of interest (ROIs), such as small, medium and/or large ROIs, within the image may be received. In block 504, convolutional layers for each image are generated successively. Each convolutional layer includes at least one convolutional feature within a region of interest.

At block 506, one or more cascaded rejection classifiers (CRCs) are applied to input regions of interest to generate a new subset of regions of interest. The CRCs may be applied to each convolutional layer using each convolutional layer's respective convolutional features. In some embodiments, multiple sets of CRCs over a plurality of convolutional layers may be employed. While each CRC may reject only a small fraction of input ROIs, multiple CRCs can efficiently remove many easy negatives earlier which gives higher computational efficiency.

In block 508, scale dependent pooling (SDP) is performed to convolutional features within the subset of regions of interest to determine a likelihood of an object category.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a convolutional neural network (CNN), the method comprising:
receiving regions of interest from an image;
generating one or more convolutional layers from the image, each of the one or more convolutional layers having at least one convolutional feature within a region of interest;
applying at least one cascaded rejection classifier to the regions of interest to generate a subset of the regions of interest; and
applying scale dependent pooling to convolutional features within the subset to determine a likelihood of an object category.

2. The method of claim 1, wherein the at least one cascaded rejection classifier rejects non-object proposals at each convolutional layer.

3. The method of claim 1, wherein the at least one cascaded rejection classifier eliminates negative bounding boxes, the negative bounding boxes including non-conforming convolutional features.

4. The method of claim 1, wherein generating the one or more convolutional layers from the image is performed once to avoid redundant feature extraction.

5. The method of claim 1, wherein the convolutional features in early convolutional layers are representative of weak classifiers.

6. The method of claim 1, wherein the scale dependent pooling determines a scale of each object proposal within each convolutional layer and pools the features from a corresponding convolutional layer dependent on the scale.

7. The method of claim 6, wherein the scale dependent pooling includes selecting an object classifier to identify the object category based on the scale.

8. A system for training a convolutional neural network (CNN), the system comprising:
a memory; and
a processor in communication with the memory, wherein the processor is configured to:
receive regions of interest from an image;
generate one or more convolutional layers from the image, each of the one or more convolutional layers having at least one convolutional feature within a region of interest;
apply at least one cascaded rejection classifier to the regions of interest to generate a subset of the regions of interest; and
apply scale dependent pooling to convolutional features within the subset to determine a likelihood of an object category.

9. The system of claim 8, wherein the at least one cascaded rejection classifier rejects non-object proposals at each convolutional layer.

10. The system of claim 8, wherein the at least one cascaded rejection classifier eliminates negative bounding boxes, the negative bounding boxes including non-conforming convolutional features.

11. The system of claim 8, wherein the processor generates the one or more convolutional layers from the image is performed once to avoid redundant feature extraction.

12. The system of claim 8, wherein the convolutional features in early convolutional layers are representative of weak classifiers.

13. The system of claim 8, wherein the scale dependent pooling determines a scale of each object proposal within each convolutional layer and pools the features from a corresponding convolutional layer dependent on the scale.

14. The system of claim 13, wherein the scale dependent pooling includes selecting an object classifier to identify the object category based on the scale.

15. A non-transitory computer-readable storage medium comprising a computer-readable program for training a convolutional neural network (CNN), wherein the computer-readable program when executed on a computer causes the computer to perform the steps of:
receive regions of interest from an image;
generating one or more convolutional layers from the image, each of the one or more convolutional layers having at least one convolutional feature within a region of interest;
applying at least one cascaded rejection classifier to the regions of interest to generate a subset of the regions of interest; and
applying scale dependent pooling to convolutional features within the subset to determine a likelihood of an object category.

16. The non-transitory computer-readable storage medium of claim 15, wherein the at least one cascaded rejection classifier rejects non-object proposals at each convolutional layer.

17. The non-transitory computer-readable storage medium of claim 15, wherein the at least one cascaded rejection classifier eliminates negative bounding boxes, the negative bounding boxes including non-conforming convolutional features.

18. The non-transitory computer-readable storage medium of claim 15, wherein the convolutional features in early convolutional layers are representative of weak classifiers.

19. The non-transitory computer-readable storage medium of claim 15, wherein the scale dependent pooling determines a scale of each object proposal within each convolutional layer and pools the features from a corresponding convolutional layer dependent on the scale.

20. The non-transitory computer-readable storage medium of claim 19, wherein the scale dependent pooling includes selecting an object classifier to identify the object category based on the scale.
